(19) United States
(12) Patent Application Publication
(10) Pub. No.: US 2026/0104851 A1
(43) Pub. Date: Apr. 16, 2026

(54) SYNCHRONOUS MUSIC STREAMING

(71) Applicant: Vibes Live, LLC, McKinney, TX (US)

(72) Inventors: John Dayani, Nashville, TN (US); Peter Clark, McKinney, TX (US); Andrew Clark, McKinney, TX (US); Robert Jacobs, Nashville, TN (US)

(73) Assignee: Vibes Live, LLC, McKinney, TX (US)

(21) Appl. No.: 19/358,813

(22) Filed: Oct. 15, 2025

Related U.S. Application Data
(60) Provisional application No. 63/707,448, filed on Oct. 15, 2024.

(51) Int. Cl. G06F 3/16; H04L 65/61

(52) U.S. Cl. CPC G06F 3/165; H04L 65/61

(57) ABSTRACT

Systems and methods are disclosed herein for synchronous music streaming. The systems and methods can determine that a first user computing device is connected to a first music streaming service and access data associated with the first music streaming service. The systems and methods can identify a playback position of a song playing in the first music streaming service based on the data and synchronize the song to the atomic clock based on the playback position. The systems and methods can determine that a second user computing device is connected to a second music streaming service and start the song in the second music streaming service at the playback position of the song based on the synchronization. The song can thereby play in sync via both music streaming services on both user computing device, regardless of the music streaming service provider and user computing device operating system.

### CROSS REFERENCE TO RELATED APPLICATIONS

This application claims priority to U.S. Provisional Patent Application No. 63/707,448, filed Oct. 15, 2024, which is incorporated herein by reference.

### TECHNICAL FIELD

The present disclosure generally relates to music sharing software, and more particularly to systems and methods for synchronous music streaming agnostic to computing device operating systems and music service software applications.

### BACKGROUND

The present disclosure generally relates to music sharing software, and more particularly to systems and methods for synchronous music streaming agnostic to computing device operating systems and music service software applications. Music streaming services, such as mobile phone music service or streaming applications, may allow users to share a song they are listening to with another user synchronously or asynchronously. However, such functionality is limited to the music service application because when users want to share the song that they are listening to with another user synchronously or asynchronously, the users must all be using the same music service (e.g., the same mobile phone music streaming application). What is needed is a platform that allows a user to listen to a song in sync with another user agnostic to either user's operating system and preferred music streaming service.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present disclosure generally relates to music sharing software, and more particularly to systems and methods for synchronous music streaming agnostic to computing device operating systems and music service software applications. In particular, a software application can allow a user (e.g., a streamer, player, producer) to share a song the streamer is currently listening to on the streamer's music application (e.g., on a mobile phone) with another user (e.g., a listener, consumer) to allow the listener to listen to the same song concurrently using the listener's preferred music service on the listener's computing device (e.g., on a mobile phone). The software application of the present disclosure can improve bandwidth and lag that may be present in a traditional broadcast model because the songs are played on each individual's user computing device instead of broadcast from one device to another device over airwaves or another medium.

One aspect of the disclosure is a non-transitory computer-readable storage medium having executable instructions stored thereon. The executable instructions, when executed by a processor, may be configured to perform one or more steps. The one or more steps may include determining that a first user computing device is connected to a first music streaming service. The steps may include accessing data associated with the first music streaming service. The steps may include identifying a playback position of a song playing via the first music streaming service on the first user computing device based on the data. The steps may include performing a synchronization of the song to a clock based on the playback position. The steps may include determining that a second user computing device is connected to a second music streaming service. The steps may include start the song on the second user computing device via an output device of the second user computing device at the playback position of the song based on the synchronization.

Another aspect of the disclosure is a method. The method may include a method of synchronous music streaming. The method may include determining, by a computing device, that a first user computing device is connected to a first music streaming service. The method may include accessing, by the computing device, data associated with the first music streaming service. The method may include identifying, by the computing device, a playback position of a song playing via the first music streaming service on the first user computing device based on the data. The method may include performing, by the computing device, a synchronization of the song to a clock based on the playback position. The method may include determining, by the computing device, that a second user computing device is connected to a second music streaming service. The method may include starting, by the computing device, the song on the second user computing device via an output device of the second user computing device at the playback position of the song based on the synchronization.

Another aspect of the disclosure is a system. The system may include at least one memory storing non-transitory computer-executable instructions. The system may include a first computing device with at least one processor for executing the non-transitory computer-executable instructions. The system may include a second computing device with one or more input devices and associated with a streamer. The system may include a third computing device with one or more audio output devices, video output devices, or a combination thereof and associated with a listener. The non-transitory computer-executable instructions, when executed by the at least one processor, may be configured to cause the first computing device to perform one or more steps. The one or more steps may include determining that the second computing device is connected to a first music streaming service. The steps may include accessing data associated with the first music streaming service. The steps may include identifying a playback position of a song playing via the first music streaming service on the second computing device based on the data. The steps may include performing a synchronization of the song to a clock based on the playback position. The steps may include determining that the third computing device is connected to a second music streaming service. The steps may include starting the song on the third computing device via the output device at the playback position of the song based on the synchronization.

Numerous other objects, advantages and features of the present disclosure will be readily apparent to those of skill in the art upon a review of the following drawings and description of various embodiments.

### BRIEF DESCRIPTION OF THE DRAWINGS

The accompanying drawings, which are incorporated in and constitute a part of the specification, illustrate exemplary embodiments of the disclosure. Together with the description, they serve to explain the objects, advantages, and principles of the disclosure.

FIGS. 1A-1B are block diagrams illustrating an example embodiment of a system of the present disclosure.

FIG. 2 is a flowchart diagram illustrating an example embodiment of a system of the present disclosure.

FIG. 3 is a flowchart diagram illustrating an example embodiment of a system of the present disclosure.

FIG. 4 is a flowchart diagram illustrating an example embodiment of a system of the present disclosure.

FIG. 5 is a flowchart diagram illustrating an example embodiment of a method of the present disclosure.

### DETAILED DESCRIPTION

Reference will now be made in detail to exemplary embodiments of the disclosure, some aspects of which are illustrated in the accompanying drawings.

Reference throughout this specification to “one embodiment,” “an embodiment,” “another embodiment,” or similar language means that a particular feature, structure, or characteristic described in connection with the embodiment is included in at least one embodiment. Thus, appearances of the phrases “in one embodiment,” “in an embodiment,” “in some embodiments,” and similar language throughout this specification may, but do not necessarily, all refer to the same embodiment, but mean “one or more but not necessarily all embodiments” unless expressly specified otherwise.

The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. As used herein, the term “a,” “an,” or “the” means “one or more” unless otherwise specified. The term “or” means “and/or” unless otherwise specified.

Multiple elements of the same or a similar type may be referred to as “Elements 102(1)-(n)” where n may include a number. Referring to one of the elements as “Element 102” refers to any single element of the Elements 102(1)-(n). Additionally, referring to different elements “First Elements 102(1)-(n)” and “Second Elements 104(1)-(n)” does not necessarily mean that there must be the same number of First Elements as Second Elements and is equivalent to “First Elements 102(1)-(n)” and “Second Elements (1)-(m)” where m is a number that may be the same or may be a different number than n.

The present disclosure is directed to systems and methods for synchronous music streaming. Provided are systems and methods that automatically sync music listening between a first user (e.g., a streamer, player, producer) playing a song and a second user (e.g., a listener, consumer) listening to the same song in sync with the streamer, regardless of the users' operating systems or preferred music services (e.g., music streaming applications). The listener can synchronously listen to the same song as the streamer by using the software application of the present disclosure which can sync the location of the streamer's song to the atomic clock to determine the precise location of the song playback and open the song at the precise location in playback in the listener's music streaming application, regardless of the streamer's and the listener's music streaming applications and operating systems. Example implementations of the systems and methods of the present disclosure include a software application operable to be installed on a mobile computing device, the application directed to fan engagement where the streamer is an athlete and streaming can occur during an event such as gameday for the athlete.

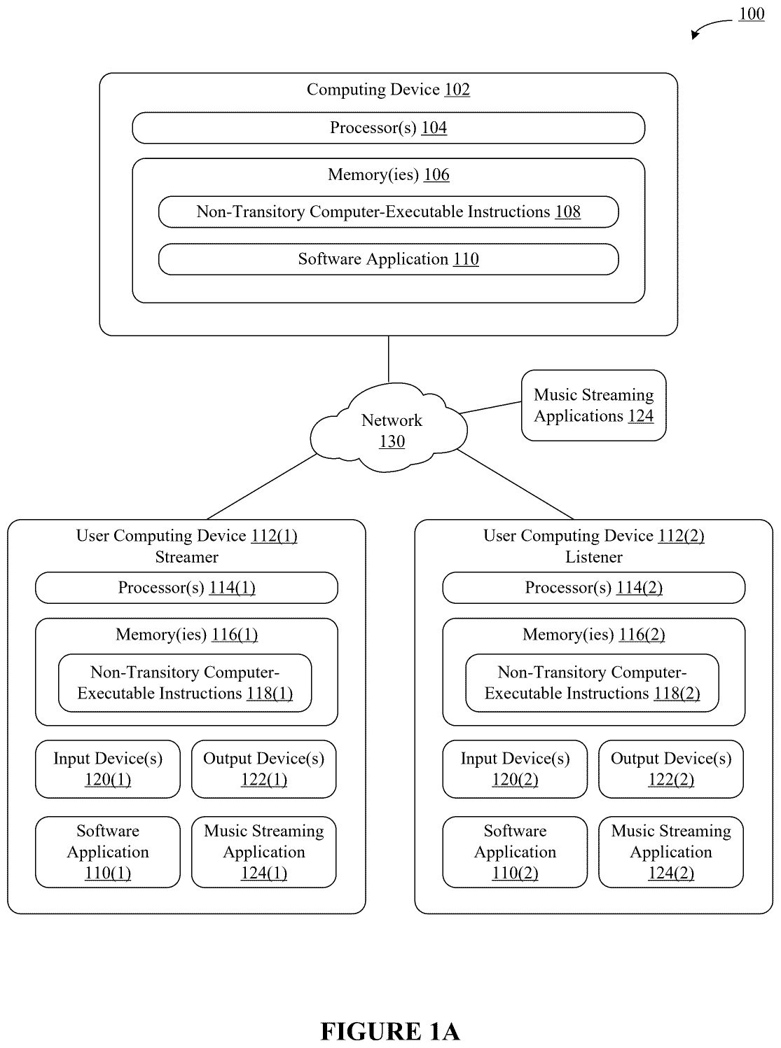

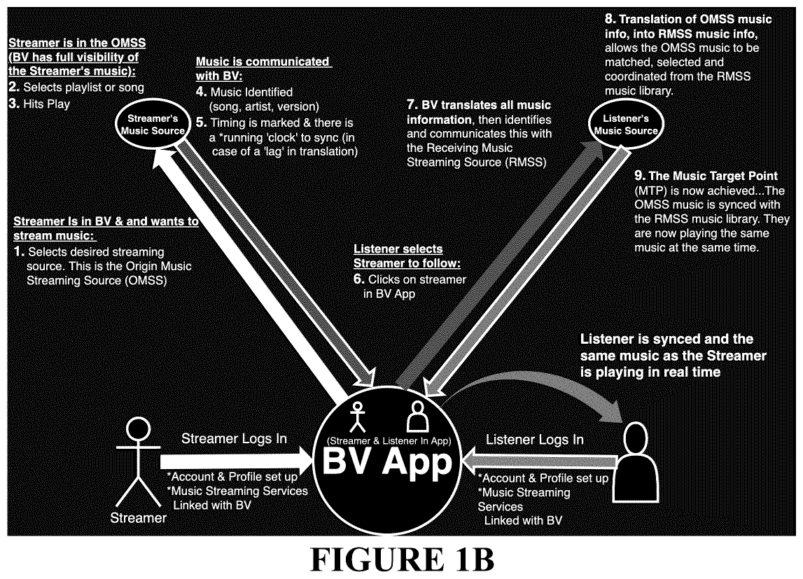

FIGS. 1A and 1B are block diagrams illustrating an example embodiment of a system 100 of the present disclosure. In the example of FIG. 1A, the system 100 may include a software application 110, such as a mobile phone application, for synchronous music streaming agnostic of operating systems and music streaming services. The software application 110 can be hosted on a central computing device 102 (e.g., the cloud, a server, etc.) of the system 100. The system 100 may include user computing devices 112(1), 112(2) (collectively, user computing devices 112), such as desktop computers, laptop computers, mobile phones, or tablet computers, as non-limiting examples. In some embodiments, the user computing devices 112 may include televisions or video game platforms. Although two user computing devices 112 are illustrated, hundreds or thousands of user computing devices may be included in the system 100. The user computing devices 112 may operate on different operating systems. The central computing device 102 may be in data communication with the user computing devices 112 over a data network 130 (e.g., the internet, a local area network (LAN), or a wide area network (WAN)). The central computing device 102 may include at least one processor 104 and one or more memories 106 storing non-transitory computer-executable instructions 108. The user computing devices 112 may also include at least one processor 114 and one or more memories 116 storing non-transitory computer-executable instructions 118, as well as one or more input devices 120 and one or more output devices 122, such as audio output devices like speakers. The non-transitory computer-executable instructions 108 stored on the one or more memories 106 of the central computing device 102, when executed by the at least one processor 104 of the central computing device 102, can cause the central computing device 102 (i.e., the software application 110) to perform one or more operations or methods described herein.

In FIG. 1B, the software application 110 is labeled “BV App.” A first user (e.g., a streamer) with a user computing device 112(1), such as a mobile phone, with the software application 110(1) installed can create a user profile and sign into the application 110(1). The user profile can include data provided by the first user, such as contact information, and can be stored in a data storage of the system 100 to be accessed by the software application 110 for authentication of the user computing device 112(1). In some examples, the streamer may receive an invite to join the software application 110 or receive an access code, link, or QR code to obtain access to install or use the software application 110(1). In the software application 110(1), the streamer may select a music streaming source, such as a music streaming application 124(1) installed on the streamer's user computing device 112(1) (e.g., Apple Music®, Spotify®). The streamer's music streaming source (i.e., music streaming application 124(1)) is referred to herein as the “Origin Music Streaming Source (OMSS).” The streamer's user computing device 112(1) may have more than one music streaming application and, in the software application 110(1), the streamer can select one of the music streaming applications as the OMSS 124(1) for streaming. For example, when creating the user profile, the software application 110(1) may allow the streamer to identify the music streaming applications that are installed on the user computing device 112(1) and select one as a preferred music streaming application, which can be used if the streamer does not select one of the music streaming applications as the OMSS 124(1) for streaming. In some examples, if there is no music streaming source installed on the user computing device 112(1), the software application 110(1) can prompt the streamer to sign up for one or more music streaming services. In another example, a playlist may be queued to play in the OMSS 124(1) and the software application 110 can determine whether any songs in the playlist are unavailable on another music streaming application and, in response, generate and send a prompt (e.g., a warning indicating that service may be interrupted for listeners) to the streamer via the software application 110(1) when a song is unavailable.

When the OMSS 124(1) is selected, the software application 110 can receive permission from the streamer (e.g., via the software application 110(1)) to access the OMSS to allow the software application to be able to communicate with the OMSS via the application programming interfaces (APIs) associated with the OMSS. As a result, the software application 110 can have full visibility of the music library of the OMSS 124(1) via the APIs associated with the OMSS. The streamer can then open the OMSS 124(1) and select a song to begin playing, which can be streamed through the OMSS 124(1) or played through OMSS 124(1) if the song is downloaded onto the user computing device 112(1). For example, the software application 110 can identify data associated with a song playing in the OMSS 124(1) in real-time by making one or more API calls to the OMSS to get the data associated with the playing song, such as the song ID, title, artist, album, version, and timing, including the precise location of the current song playback. A music identification mark (MIM) can be used by the software application 110 to identify the data about the currently playing song (e.g., song, artist, version, playback time, and other information about the song that is currently playing).

The software application 110 can mark the precise location of the current song playback based on the MIM to synchronize the song so that a listener (e.g., user computing device 112(2)) can play the same song at the same time location in sync with the streamer. For example, the software application 110 can make an API call to the API associated with the OMSS to receive data about the song that is currently playing in the OMSS (i.e., the MIM—song ID, title, artist, album, version, timing, etc.), parse the data to identify the timestamp of the currently playing song, and sync the song to the atomic clock (e.g., the system time of the user computing device 112(1) which is based on the atomic clock) based on the timestamp. For instance, the software application 110 can mark that the song is at the 1:43 timestamp when the atomic clock time is 10:01:43. In another example, if the song is currently at the 1:43 mark, and the current time based on the atomic clock is 10:01:43, then the software application 110 can calculate that the song started at 10:00:00. In some implementations, the song can be marked at a timestamp based on fractions of seconds, such as marking that the song is at the 1:43.03 or the 1:43.035452 timestamp when the atomic clock time is 10:01:43.03 or 10:01:43.035452 respectively. As a result, the software application 110 can identify currently playing songs in real-time. In another example, the software application 110 can mark the location of the current song playback by incrementing a running time counter to synchronize the timing of the song.

A second user (e.g., a listener) with a user computing device 112(2), such as a mobile phone, with the software application 110(2) installed can create a user profile and sign into the application 110(2). The user profile can include data provided by the second user, such as contact information, and can be stored in a data storage of the system 100 to be accessed by the software application 110 for authentication of the user computing device 112(2). In some examples, the listener may receive an invite to join the software application 110 or receive an access code, link, or QR code to obtain access to install or use the software application 110(2). In the software application 110(2), the listener may select a music streaming source, such as a music streaming application 124(2) installed on the listener's user computing device 112(2) (e.g., Apple Music®, Spotify®). The listener's music streaming source (i.e., music streaming application 124(2)) is referred to herein as the “Receiving Music Streaming Source (RMSS).” The listener's user computing device 112(2) may have more than one music streaming application and, in the software application 110(2), the listener can select one of the music streaming applications as the RMSS 124(2) for listening. For example, when creating the user profile, the software application 110(2) may allow the listener to identify the music streaming applications that are installed on the user computing device 112(2) and select one as a preferred music streaming application, which can be used if the listener does not select one of the music streaming applications as the RMSS 124(2) for listening. In some examples, if there is no music streaming application installed on the user computing device 112(2), the software application 110(2) can prompt the listener to sign up for one or more music streaming services. In some examples, a song that is currently being played by the streamer in the OMSS 124(1) may not be available on the RMSS 124(2) and, in response, the software application 110(2) can open another one of the listener's music streaming applications as the RMSS 124(2) for listening based on the user profile, or can prompt the listener to sign up for the music streaming application that is needed to listen to the song.

When the RMSS 124(2) is selected, the software application 110 can receive permission from the listener (e.g., via the software application 110(2)) to access the RMSS to allow the software application to be able to communicate with the RMSS via the APIs associated with the RMSS. As a result, the software application 110 can have full visibility of the music library of the RMSS 124(2) via the APIs associated with the RMSS. The OMSS 124(1) may be different from the RMSS 124(2). For example, the OMSS may be Spotify® and the RMSS may be Apple Music®.

The software application 110(2) may include a user interface that displays users that are currently streaming music (e.g., streamers). The user interface may be generated by the computing device 102 by receiving the permission from the streamer (e.g., via the software application 110(1)) to access the OMSS and adding the streamer to a list of currently active streamers to display on the software application 110(2) in response. In the software application's 110(2) user interface, the listener may view the current streamers and select one of the streamers to follow.

In response to receiving a selection of a streamer from the listener, the software application 110 can access the MIM (e.g., data such as song ID, title, artist, album, version, timing, etc.) associated with the song playing in the OMSS 124(1) that is associated with the selected streamer, translate that data to a format the RMSS 124(2) can understand, and send the translated data to the RMSS 124(2) APIs. In particular, the song ID of the song can be translated from a format that the OMSS 124(1) understands to a format that the RMSS 124(2) understands so that the same song can be played at the same time on both user computing devices. For instance, the software application 110 can parse the MIM to get the song ID (and confirm the song title, artist, album, etc.) and playback position for the song playing in the OMSS, translate the song ID to the format that is understood by the RMSS, and send the translated song ID and playback position in an API request to the RMSS, which allows the RMSS to launch the same song in the RMSS application (which may be referred to herein as “interpreted music (IM),” as the IM is played by the RMSS after the MIM is identified and translated through the software application 110). The song can be played in the RMSS at the same time as in the OMSS based on the synchronization to the atomic clock as described above. Similar to the song playing in the OMSS, the song playing in the RMSS can be streamed through the RMSS or downloaded onto the user computing device 112(2) and played through RMSS. The translated song ID can be stored in a database or other data storage device that can be accessed by the software application 110, thereby reducing the time to prepare the RMSS 124(2) to play a song by allowing the software application 110 to retrieve the translated song ID from the database instead of translating the MIM again.

In some examples, the software application 110 can determine that a playlist is queued to play in the OMSS 124(1) (e.g., the streamer started playing a song in the playlist and a queue of the songs to be played next is generated), access the MIM (i.e., data) associated with each song in the playlist, translate that data to a format that the RMSS 124(2) can understand, and store the translated data in the database. The database can include records that correlate the song ID in the OMSS format to the song ID in the RMSS format. As the playlist progresses in the OMSS 124(1), the software application 110 can obtain the OMSS song ID and access the record for the OMSS song ID in the database to retrieve the RMSS song ID for that song. The process can continue so that the database is consistently reconciled with accurate song IDs as the playlist is played by accessing the MIM associated with each song, translating that data, and updating the database accordingly. As a result, if the streamer skips a song in the playlist or shuffles the playlist, the software application 110 can move onto the next song by retrieving the RMSS song ID for the next song from the database. In this way the RMSS is a mirror of the OMSS. In some implementations, the software application 110 can store the playlist in the database or another storage device prior to accessing the MIM and translating that data.

There may be a short delay or lag during this processing of information between the OMSS and the RMSS, referred to herein as “music interpretation lag (MIL).” The software application 110 may account for any MIL by timing the delay. Continuing the example from above, the song can be started in the RMSS 124(2) in the same playback position as the song is currently in on the OMSS 124(1) when the software application 110 retrieves the mark for the song which identifies that the song was at the 1:43 timestamp when the atomic clock time was 10:01:43, determine based on the atomic clock of the user computing device 112(2) (e.g., the system time) that the current time is 10:01:44, and calculate that the song must currently be at the 1:44 timestamp in the OMSS, so the song is started in the RMSS at the 1:44 timestamp (which accounts for the one second delay). In another example, the software application 110 can identify, based on the mark, that the song started in the OSS at 10:00:00, obtain the current time of the atomic clock of the user computing device 112(2) as 10:01:44, calculate that the song should start at the 1:44 timestamp, and start the song in the RMSS at the 1:44 timestamp (which accounts for the one second delay). As a result, the songs are in sync and the streamer's computing device 112(1) and the listener's computing device 112(2) are playing the same song at the same time through the OMSS 124(1) and the RMSS 124(2) respectively. This process may be referred to as the software application 110 “merging” the MIM (e.g., song ID at 1:43 timestamp) and IM (e.g., song associated with the translated song ID) with the MIL (e.g., 1 second delay) to achieve proper timing and exact syncing of the currently playing song on both the streamer's computing device 112(1) (e.g., in the OMSS) and the listener's computing device 112(2) (e.g., in the RMSS). In some embodiments, this merging (referred to herein as “target synchronization (TS)”) may be between 12 milliseconds and 15 milliseconds. In some embodiments, the TS may be between 20 milliseconds and 30 milliseconds. In some embodiments, the TS may be between 12 milliseconds and 20 milliseconds. In some embodiments, the TS may be between 12 milliseconds and 30 milliseconds. In some embodiments, the TS may be between 15 milliseconds and 20 milliseconds. In some embodiments, the TS may be between 15 milliseconds and 30 milliseconds.

In some embodiments, the streamer may select a playlist of songs in the OMSS 124(1) and play a song from the playlist. The software application 110 can identify data associated with the song playing in the OMSS 124(1), as well as the playlist the song is playing from, in real-time by making one or more API calls to the OMSS 124(1) to get the data associated with the playing song and the playlist, including the precise location of the current song playback and the location of the song in the playlist. The software application 110 can synchronize the timing of the song as provided in the examples above. When a listener selects the streamer playing a playlist, the currently playing song can be started in the RMSS 124(2) in the same playback position as the song is currently on in the OMSS 124(1), as provided in the examples above, and continue onto the next song in the playlist in sync with the movement to the next song in the OMSS. This visibility into a streamer's playlist in the OMSS 124(1) also allows the software application 110 to duplicate playlists for multiple different streaming services (e.g., by accessing the MIM and translation described above), so that if a streamer decides to play the playlist, the software application 110 can anticipate the next song across multiple different music streaming services so as to reduce latency.

In some examples, the streamer may pause the song that is currently playing in the OMSS. In response, the software application 110 can send a notification to the user computing device 112(2) (e.g., via the software application 110(2) indicating that the streamer paused the song and pause the song as it is currently playing in the RMSS.

In some embodiments, the software application 110 can provide functionality for another user to schedule a time period when a song or playlist can be played via the OMSS 124(1). The other user may be a person other than the streamer or the listener (e.g., an administrator, manager, coach, etc. of the streamer) who is authorized by the streamer or the listener, respectively, with a user computing device for accessing the software application 110(3). The software application 110(3) can have a user interface that allows for setting a time period (e.g., a number of minutes or hours, or a time of day) when the music can be streamed via the OMSS 124(1) on the streamer's user computing device 112(1) such that a listener can listen to the same music in sync. In response to the time period being set by the other user, the software application 110 has permission to access the OMSS, which allows the software application to communicate with the OMSS via the APIs associated with the OMSS during that time period. When the streamer opens the OMSS 124(1) and selects a song or playlist to begin playing during the scheduled time, the songs can be streamed through the OMSS or played through the OMSS if the songs are downloaded onto the user computing device 112(1). The songs can then be synced as described above so that listeners can play the same songs at the same time as the streamer during this time period via the RMSS 124(2) on the listeners' user computing devices.

In some embodiments, the streamer may use the software application 110 to provide a voice-activated live microphone for public access (referred to herein as a “live mic”). The streamer may give the software application 110 permission to access a microphone or other input device 120(1) of the user computing device 112(1) associated with the streamer, such as by opening the software application 110(1) on the user computing device 112(1) and authorizing the access to the input device 120(1) (e.g., a microphone). The live mic may be voice activated, where a streamer can say a prompt that will turn on the live mic, and the live mic may be turned off based on a setting configured by the streamer in the software application 110(1), such as an amount of “dead air” time after the streamer speaks (e.g., three seconds, five seconds, ten seconds, etc.) that is tracked by the software application 110, or based on a preselected live mic activation time set by the streamer in the software application 110(1). In some examples, the software application 110(1) may present a user interface (UI) on the user computing device 112(1) that displays a toggle switch or other UI element that allows the streamer to “turn on” the input device 120(1), and, in response, the software application 110 can provide the live mic. In some embodiments, a two-step verification process may be presented by the software application 110(1) to the streamer to turn on the live mic. The software application 110 can then allow a listener to listen to the live mic being streamed by the streamer through an output device 122(2) of the user computing device 112(2) associated with the listener. For example, a UI of the software application 110(2) may display users that currently have a live mic activated (i.e., streamers). The UI may be generated by the computing device 102 by receiving the permission from the streamer (e.g., via the software application 110(1)) to access the input device 120(1) and adding the streamer to a list of currently active streamers to display on the software application 110(2) UI. In the software application's 110(2) UI, the listener may view the current streamers and select one of the streamers to follow. In response, the software application 110 can capture the live input from the streamer into the input device 120(1) (e.g., a microphone) and stream the input in real-time to the output device 122(2) for the listener to hear in real-time. For example, the streamer may be an athlete giving an interview, the streamer may authorize the software application 110 to access the microphone of their device (e.g., the input device 120(1) of the user computing device 112(1)), and the software application 110 may allow a listener with another device to hear the interview in real-time through a speaker of their device (e.g., the output device 122(2) of the user computing device 112(2)) until the streamer turns off the microphone. In some embodiments, if the streamer is listening to a song in the OMSS, then when the streamer provides the software application 110 with access to the input device 120(1), the software application 110 can pause the song, which will also pause the song in the RMSS of any listener who is listening to the same music as the streamer in sync, to switch to the live mic. The software application 110 can then automatically resume the song in the OMSS at the same timestamp where the song was paused when the live mic is turned off by the streamer, and the song will automatically resume playing in the RMSS at the same timestamp so that the streamer and listener are listening to the song in sync again.

In some embodiments, an administrator can be provided with administrator access to an instance of the software application (e.g., software application 110(1) of the streamer's user computing device 112(1)) to be able to set parameters on the use of the software application for the user. For example, the streamer may be an athlete and the administrator may be a coach who can set a particular time period for when the athlete can and cannot use the software application 110(1), such as during game time. During that particular time period, the software application 110 may not be authorized to access the OMSS to allow the software application to be able to communicate with the OMSS via the APIs associated with the OMSS, and as a result, a listener may not be able to follow the streamer in the software application 110(2).

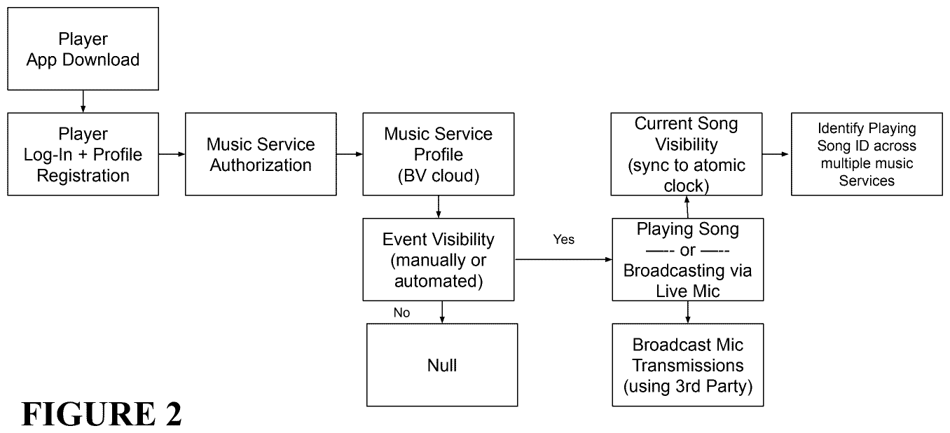

FIG. 2 is a flowchart diagram illustrating an example embodiment of a system of the present disclosure. In the example of FIG. 2, a streamer (i.e., player) profile user flow of the system 100 is illustrated. The streamer can download the software application 110(1) onto the streamer's user computing device 112(1) (e.g., a mobile phone). The streamer can then create a user profile and sign into the application, as well as sign into the streamer's music streaming source, such as a music streaming application 124(1) installed on the streamer's user computing device (e.g., Apple Music®, Spotify®). The streamer's user profile may be accessible by the central computing device 102 and stored within the system 100.

An event may be visible, such as when a streamer chooses to play music through their music streaming application 124(1), and the software application 110 can access the music streaming application 124(1) to allow the software application to be able to communicate with the music streaming application 124(1) via the APIs associated with the music streaming application 124(1) to have full visibility of the music library of the music streaming application 124(1). In some embodiments, the streamer may use the software application 110 to provide a voice-activated live microphone for public access (i.e., the live mic).

The software application 110 can identify data associated with a song playing in the music streaming application 124(1) in real-time by making one or more API calls to the music streaming application to get the data associated with the playing song. The software application 110 can mark the precise location of the current song playback and synchronize the song to the atomic clock (as described above) so that a listener (e.g., user computing device 112(2)) can play the same song at the same time on any music streaming application and any operating system.

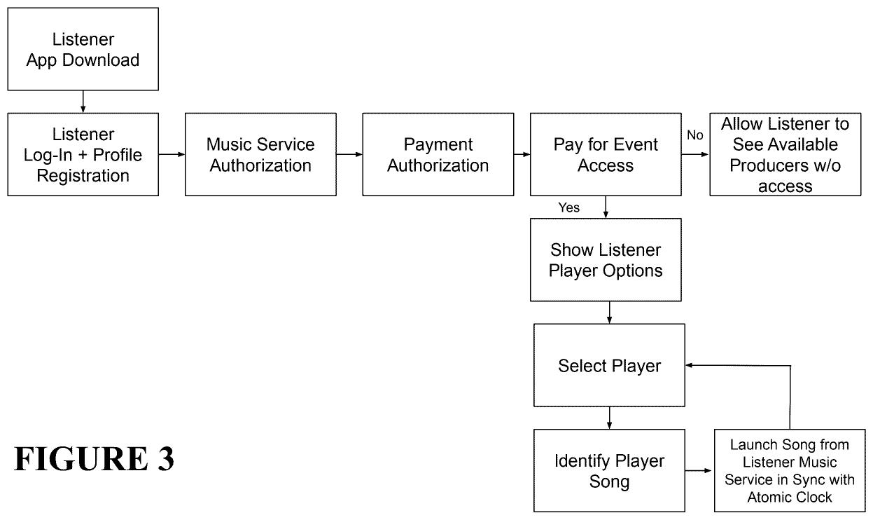

FIG. 3 is a flowchart diagram illustrating an example embodiment of a system of the present disclosure. In the example of FIG. 3, a listener profile user flow of the system 100 is illustrated. The listener can download the software application 110(2) onto the listener's user computing device 112(2) (e.g., mobile phone). The listener can then create a user profile and sign into the application, as well as sign into the listener's music streaming source, such as a music streaming application 124(2) installed on the listener's user computing device (e.g., Apple Music®, Spotify®). The software application 110 may prompt the listener for a payment to allow the listener access to an event, which may be provided via a third-party payment service or integration. If the listener successfully pays for the event access, the software application 110 can generate and display a list of streamers (i.e., players) currently streaming music, and accept a selection of a streamer from the listener. If the listener does not pay for the event access, the software application 110 can generate and display a list of streamers currently streaming music on the software application, however the listener may not be provided access to select a streamer from the list.

When a streamer is selected, the software application 110 can identify the song that the streamer is currently listening to by making one or more API calls to the OMSS 124(1) to get the data associated with the playing song, including the precise location of the current song playback, marking the precise location of the current song playback (e.g., syncing to the atomic clock), translating the data associated with the song playing in the OMSS, sending the translated data to the RMSS 124(2), which can be received by APIs associated with the RMSS, and launching the song in the RMSS in sync with the atomic clock so that the song is in the same playback position as the song is currently playing in the OMSS.

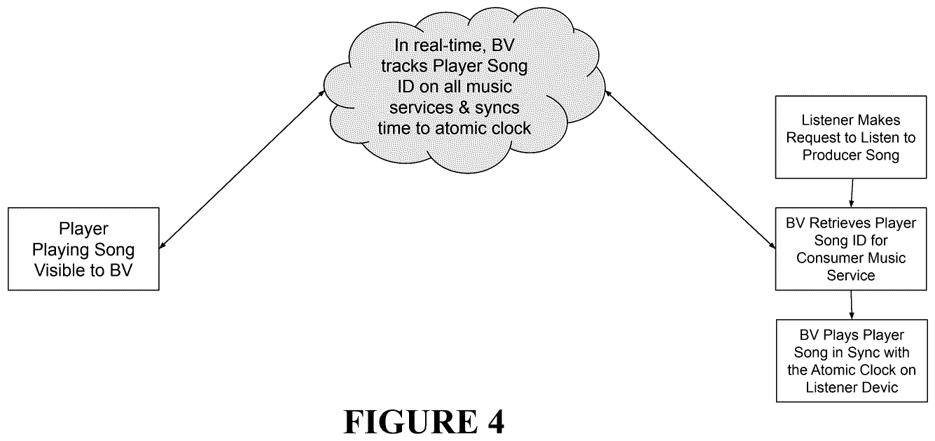

FIG. 4 is a flowchart diagram illustrating an example embodiment of a system of the present disclosure. In the example of FIG. 4, the software application 110 can identify data associated with the song that a streamer (i.e., player) is playing in the OMSS 124(1) in real-time by making one or more API calls to the OMSS to get the data associated with the playing song, such as the title, artist, version, and timing, including the precise location of the current song playback. The software application 110 can track the song ID of the song the streamer is currently playing. The timing of currently playing song can be synced to the atomic clock as described above.

The listener can make a request to listen to the song the streamer is currently playing in sync. For example, in the software application's 110(2) user interface, the listener can view the current streamers and select one of the streamers to follow, which can cause the listener's computing device 112(2) to send a request to the central computing device 102 to synchronize with the streamer's currently playing song on the streamer's computing device 112(1) to the atomic clock. In response to receiving the request, the central computing device 102 can retrieve the song ID of the song the streamer is currently playing and play the song in sync with the atomic clock on the listener's computing device 112(2) through the RMSS 124(2). For example, the central computing device 102 can translate the data (e.g., the song ID) associated with the song playing in the OMSS 124(1) and send the translated data to the RMSS 124(2), which can be received by APIs associated with the RMSS. When the translated data is sent to the RMSS 124(2), the listener's user computing device 112(2) can launch, in the RMSS, the song that is currently playing in the OMSS 124(1). The song can be started in the RMSS 124(2) in the same playback position as the song is currently in on the OMSS 124(1) since the song playback is in sync with the atomic clock.

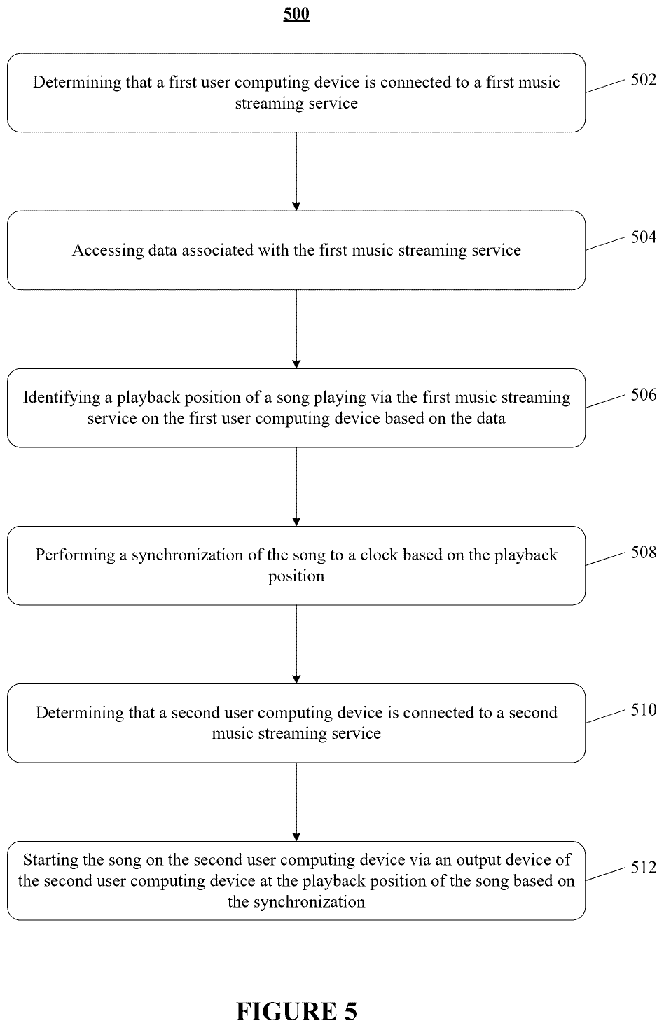

FIG. 5 is a flowchart diagram illustrating an example embodiment of a method 500 of the present disclosure. In certain embodiments, the method 500 for synchronous music streaming may include the step of providing one or more memories. The memories may store non-transitory computer-executable instructions for synchronous music streaming. The method 500 may include operation 502 of determining that a first user computing device is connected to a first music streaming service. The method 500 may include operation 504 of accessing data associated with the first music streaming service. The method 500 may include operation 506 of identifying a playback position of a song playing via the first music streaming service on the first user computing device based on the data. In some embodiments, identifying the playback position of the song may include sending, via an API associated with the first music streaming service, a request for data associated with an account for the first user computing device, receiving the data associated with the account for the first user computing device, and parsing the data associated with the account for the first user computing device for the playback position of the song. The method 500 may include operation 508 of performing a synchronization of the song to a clock based on the playback position. For example, the clock can be the atomic clock. The method 500 may include operation 510 of determining that a second user computing device is connected to a second music streaming service. The first music streaming service may be different from the second music streaming service. The method 500 may include operation 512 of starting the song on the second user computing device via an output device of the second user computing device at the playback position of the song based on the synchronization.

In some embodiments, the method 500 may include translating the data associated with the first music streaming service to generate translated data, accessing, based on the translated data, data associated with the second music streaming service, and identifying the song based on the data associated with the second music streaming service. In another example, the method 500 may include determining that a plurality of user computing devices are connected to a music streaming service, wherein each user computing device of the plurality of user computing devices is associated with a streamer, generating a list comprising each streamer associated with each user computing device of the plurality of user computing devices, and displaying the list on a user interface of the second user computing device. In some embodiments, the method 500 may include determining, based on the data associated with the first music streaming service, that the song is part of a playlist of songs, subsequent to starting the song on the second user computing device, determining that a subsequent song in the playlist is playing via the first music streaming service on the first user computing device, and starting the subsequent song on the second user computing device via the output device of the second user computing device based on the synchronization. In another embodiment, the method 500 may include receiving user data from the first user computing device and creating a user profile associated with the first user computing device based on the user data.

The presently disclosed systems and methods have a wide application anywhere in the computer industry where synchronous music streaming is needed. One particularly important application for the systems and methods described herein relates to music synchronization among computing devices with different operating systems and music streaming applications. Additional systems and methods include entertainment devices that allow for live streaming. However, the systems and methods described above could be utilized in other contexts.

As used herein, the term “computing device” may include a processor-controlled device, such as, by way of example, a personal computer, workstation, server, client, mini-computer, mainframe computer, desktop computer, laptop computer, smartphone, tablet, network of one or more individual computers, mobile computer, portable computer, handheld computer, or any combination thereof. The described systems and techniques may be performed by a system that includes a single computing device or more than one computing device.

A computing device may include an integrated circuit (IC) and may include an application-specific integrated circuit (ASIC) or some other type of IC. A computing device may be a uniprocessor or multiprocessor machine. Accordingly, a computing device may include one or more processors and, thus, the system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field-programmable gate arrays (FPGAs), programmable logic devices (PLDs), gated logic, and other suitable hardware configured to perform the various functionality described throughout this disclosure. In some embodiments, features of the system can be implemented primarily in hardware using, for example, hardware components such as application-specific integrated circuits (ASICs) or field-programmable gated arrays (FPGAs). Implementation of the hardware circuitry will be apparent to persons skilled in the relevant art(s). In yet another embodiment, features of the system can be implemented using a combination of both general-purpose hardware and software.

The computing device may include one or more memories. Accordingly, the system may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, videotapes, audio tapes, magnetic recording tracks, magnetic tunnel junction (MTJ) memory, optical memory storage, quantum mechanical storage, electronic networks, and/or other devices or technologies used to store electronic content such as programs and data. A basic input/output system (BIOS) can include basic routines that help to transfer information between elements within the system, such as during start-up, can be stored in the one or more memories.

The system can also include one or more storage devices. Examples of a storage device include, but are not limited to, a hard disk drive, a magnetic disk drive, an optical disc drive in combination with an optical medium, a solid-state memory device, or any combination thereof. A storage device can be connected to a bus by an appropriate interface, such as an SCSI, advanced technology attachment (ATA), serial ATA, universal serial bus (USB), IEEE 1394 (FIREWIRE), or any combination thereof. A storage device (or one or more components thereof) can be removably interfaced with the system (e.g., via an external port connector). The storage device and an associated computer-readable medium can provide nonvolatile and/or volatile storage of computer-executable instructions, data structures, program modules, and/or other data for the system.

In particular, the one or more memories may store computer-executable instructions that, when executed by the one or more processors, cause the one or more processors to implement the procedures and techniques described herein. The one or more processors may be operably associated with the one or more memories so that the computer-executable instructions can be provided to the one or more processors for execution. For example, the one or more processors may be operably associated to the one or more memories through one or more buses. Furthermore, the computing device may possess or may be operably associated with input devices (e.g., a keyboard, a keypad, controller, a mouse, a microphone, a touch screen, a sensor) and output devices such as (e.g., a computer screen, printer, or a speaker).

The computer-executable instructions described herein can be downloaded to respective computing/processor devices from a computer-readable storage medium or to an external computer or external storage device via a network, for example, the Internet, a local area network (LAN), a wide area network (WAN) and/or a wireless network. The network may comprise copper transmission cables, optical transmission fibers, wireless transmission, routers, firewalls, switches, gateway computers and/or edge servers. A network adapter card or network interface in each computing/processor device receives computer readable program instructions from the network and forwards the computer readable program instructions for storage in a computer readable storage medium within the respective computing/processor device.

The computing device may execute an appropriate operating system such as LINUX®, UNIX®, MICROSOFT® WINDOWS®, APPLE® MACOS®, IBM® OS/2®, ANDROID, and/or the like. The computing device may advantageously be equipped with a network communication device such as a network interface card, a modem, or other network connection device suitable for connecting to one or more networks.

A computing device may advantageously contain control logic, or program logic, or other substrate configuration representing data and instructions, which cause the computing device to operate in a specific and predefined manner as, described herein. In particular, the computing device programs, when executed, enable a control processor to perform and/or cause the performance of features or operations of the present disclosure. The control logic may advantageously be implemented as one or more modules. The modules may advantageously be configured to reside on the computing device memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and/or the like. The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells. The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

As will be appreciated by one skilled in the art, aspects of the present disclosure may be embodied as an apparatus, system, method, computer program product, or the like. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present disclosure may take the form of a computer program product embodied in one or more computer readable medium(s) having program code embodied thereon.

It should be understood that manipulations within the computing device are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computing device or computing devices.

It should also be understood that the programs, modules, processes, methods, and the like, described herein are but an exemplary implementation and are not related, or limited, to any particular computing device, apparatus, or computer language. Rather, various types of general-purpose computing machines or devices may be used with programs constructed in accordance with some of the teachings described herein. In some embodiments, very specific computing machines, with specific functionality, may be required. Similarly, it may prove advantageous to construct a specialized apparatus to perform the method steps described herein by way of dedicated systems with hard-wired logic or programs stored in nonvolatile memory, such as, by way of example, read-only memory (ROM).

Aspects of the present disclosure are described herein with reference to flowchart illustrations or block diagrams of methods, apparatuses, systems, or computer program products according to embodiments of the disclosure. It will be understood that each block of the flowchart illustrations and/or block diagrams, and combinations of blocks in the flowchart illustrations and/or block diagrams, can be implemented by computer-executable instructions. These computer-executable instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-executable instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The schematic flow chart diagrams included herein are generally set forth as logical flow chart diagrams. As such, the depicted order and labeled steps are indicative of one embodiment of the presented method. Other steps and methods may be conceived that may be equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown. The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions of the program code for implementing the specified logical function(s).

While the making and using of various embodiments of the present disclosure are discussed in detail herein, it should be appreciated that the present disclosure provides many applicable inventive concepts that are embodied in a wide variety of specific contexts. The specific embodiments discussed herein are merely illustrative of specific ways to make and use the disclosure and do not delimit the scope of the disclosure. Those skilled in the art will recognize, or be able to ascertain, using no more than routine experimentation, numerous equivalents to the specific substances and procedures described herein. Such equivalents are considered to be within the scope of this disclosure and are covered by the following exemplary claims.

Furthermore, the described features, structures, or characteristics of the disclosure may be combined in any suitable manner in one or more embodiments. In the description contained herein, numerous specific details are provided to provide understanding of embodiments of the disclosure. One skilled in the relevant art will recognize, however, that the disclosure may be practiced without one or more of the specific details, or with other methods, components, materials, apparatuses, devices, systems, and so forth. In other instances, well-known structures, materials, or operations may not be shown or described in detail to avoid obscuring aspects of the disclosure.

Those skilled in the art will recognize improvements and modifications to the preferred embodiments of the present disclosure. All such improvements and modifications are considered within the scope of the concepts disclosed herein and the claims that follow.

What is claimed is:

1. A computer-implemented method for synchronous music streaming, the computer-implemented method comprising:
determining, by a computing device, that a first user computing device is connected to a first music streaming service;
accessing, by the computing device, data associated with the first music streaming service;
identifying, by the computing device, a playback position of a song playing via the first music streaming service on the first user computing device based on the data;
performing, by the computing device, a synchronization of the song to a clock based on the playback position;
determining, by the computing device, that a second user computing device is connected to a second music streaming service; and
starting, by the computing device, the song on the second user computing device via an output device of the second user computing device at the playback position of the song based on the synchronization.

2. The computer-implemented method of claim 1, wherein the clock is an atomic clock.

3. The computer-implemented method of claim 1, wherein the first music streaming service is different from the second music streaming service.

4. The computer-implemented method of claim 1, further comprising:
translating the data associated with the first music streaming service to generate translated data;
accessing, based on the translated data, data associated with the second music streaming service; and
identifying the song based on the data associated with the second music streaming service.

5. The computer-implemented method of claim 1, further comprising:
determining that a plurality of user computing devices are connected to a music streaming service, wherein each user computing device of the plurality of user computing devices is associated with a streamer;
generating a list comprising each streamer associated with each user computing device of the plurality of user computing devices; and
displaying the list on a user interface of the second user computing device.

6. The computer-implemented method of claim 1, wherein identifying the playback position of the song playing via the first music streaming service on the first user computing device based on the data comprises:
sending, via an API associated with the first music streaming service, a request for data associated with an account for the first user computing device;
receiving the data associated with the account for the first user computing device; and
parsing the data associated with the account for the first user computing device for the playback position of the song.

7. The computer-implemented method of claim 1, further comprising:
determining, based on the data associated with the first music streaming service, that the song is part of a playlist of songs;
subsequent to starting the song on the second user computing device, determining that a subsequent song in the playlist is playing via the first music streaming service on the first user computing device; and
starting the subsequent song on the second user computing device via the output device of the second user computing device based on the synchronization.

8. The computer-implemented method of claim 1, further comprising:
receiving user data from the first user computing device; and
creating a user profile associated with the first user computing device based on the user data.

9. A non-transitory computer-readable storage medium having executable instructions stored thereon, wherein the executable instructions, when executed by a processor, are configured to:
determine that a first user computing device is connected to a first music streaming service;
access data associated with the first music streaming service;
identify a playback position of a song playing via the first music streaming service on the first user computing device based on the data;
perform a synchronization of the song to a clock based on the playback position;
determine that a second user computing device is connected to a second music streaming service; and
start the song on the second user computing device via an output device of the second user computing device at the playback position of the song based on the synchronization.

10. A system for synchronous music streaming, the system comprising:
at least one memory storing non-transitory computer-executable instructions;
a first computing device with at least one processor for executing the non-transitory computer-executable instructions;
a second computing device with one or more input devices and associated with a streamer; and
a third computing device with one or more audio output devices, video output devices, or a combination thereof and associated with a listener;
wherein, when executed by the first computing device, the non-transitory computer-executable instructions cause the first computing device to perform operations comprising:
determining that the second computing device is connected to a first music streaming service;
accessing data associated with the first music streaming service;
identifying a playback position of a song playing via the first music streaming service on the second computing device based on the data;
performing a synchronization of the song to a clock based on the playback position;
determining that the third computing device is connected to a second music streaming service; and
starting the song on the third computing device via the output device at the playback position of the song based on the synchronization.
